(19) United States
(12) Patent Application Publication
(10) Pub. No.: US 2020/0319602 A1
(43) Pub. Date: Oct. 8, 2020

(54) TIMER APPARATUS

(71) Applicant: Hiroyuki Ogura, Kenilworth, NJ (US)

(72) Inventors: Hiroyuki Ogura, Kenilworth, NJ (US); Mei Noguchi, (US)

(21) Appl. No.: 16/838,836

(22) Filed: Apr. 2, 2020

Related U.S. Application Data
(60) Provisional application No. 62/828,456, filed on Apr. 2, 2019.

(51) Int. Cl. G04G 17/08; G04G 9/02; G04G 11/00; G04G 13/02; G04G 21/02

(52) U.S. Cl. CPC G04G 17/08; G04G 9/02; G04G 21/02; G04G 13/025; G04G 11/00

(57) ABSTRACT

A timer apparatus is described. A shape of the timer apparatus includes a cube, a pyramid, a pentagonal prism, a hexagonal prism, or a polygonal prism. The shape of the timer apparatus is preferable a cube. The timer apparatus also includes timing surface(s). Each of the timing surface(s) displays a value in minutes/seconds from which to countdown. The timer apparatus also includes a display surface. The display surface provides a timer and controls associated with the timer apparatus. The timer is configured to countdown from the value displayed by the timing surface when the timing surface is detected in a top position. The timer apparatus also includes a stop surface. When the stop surface is detected in the top position, the timer is reset. Furthermore, the timer apparatus includes a controller and an orientation sensor.

### CLAIM OF PRIORITY

This application is a U.S. Non-Provisional Patent Application that claims priority to U.S. Provisional Application Ser. No. 62/828,456 filed on Apr. 2, 2019, the entire contents of which are hereby incorporated by reference.

### FIELD OF THE EMBODIMENTS

The field of embodiments of the present invention related to a surface orientation based timer with a display component.

### BACKGROUND OF THE EMBODIMENTS

A timer includes a special clock that is configured to count down from a set value. The set value is user configurable. For example, a user may configure the timer to count down from a set value. The timer may start a count down. Upon reaching zero or an end of the set value, the timer may emit an alert. The alert may include an audible alert that the user may be allowed to pause and/or reset. As such, the timer may aid the user to keep track of a timer interval.

Below are some examples of timer based apparatus.

For instance, U.S. Pat. No. 9,547,281 pertains to an electronic interval timer in a dodecahedron case. The timer is set by turning uppermost one of 11 faces; and reset by turning uppermost the 12th face. In one embodiment, the timer is free of buttons, knobs, springs, time displays, electronic visual indicators and openings in the case. Time interval completion is announced via audible tones or speech. An aggregate time interval may be set equal to the sum of legends on more than one face. The timer detects carrying such that a running time interval is not modified. The timer may be programmed via a sequence of uppermost sides. Modes may be selected via shaking or tapping. Time remaining may be announced, an interval cleared, or an interval restarted responsive to detected motion. Other polyhedral shapes may be used. Claims include a method of setting a time interval; and specific ordering of face legends.

U.S. Pat. No. 6,685,353 pertains to a clock apparatus comprising a clock case made of either an opaque material or a translucent material, the clock case enclosing an electronic circuit comprising electronic circuit elements including: a clock timer, a source of electrical current, a power switch, a switching device, and a means for illumination. The clock case comprises a pair of cubes, with an upper one of the cubes mounted at one corner, on a face of a lower one of the cubes. The cubes provide apertures having a distribution on the clock case in correspondence with the dots of a pair of dice. Windows made of either an opaque or a translucent material, cover the apertures so that light from the illumination means of the electrical circuit is visible through either the clock case or the windows as a light show in accordance with the switching device. A clock face is engaged with the clock timer and is mounted on one of the faces of the upper one of the cubes so as to be visible to a viewer of the light show.

U.S. Pat. No. 8,465,356 pertains to a geometric toy having a two or more axes originating from the center of the toy. The geometric toy includes cubelets. A predetermined number of the cubelets are rotatable about the axes. Display screens are connected to the cubelets and allow for the display of preprogrammed images. At least one microprocessor is in communication with the display screens to control the display of images on the display screens. A connection means allows for the rotation of the cubelets about the axes while still maintaining communication between the microprocessor and the display screens to provide for the continual display of images on the display screen.

U.S. Pub. 2005/0164778A1 pertains to a game die for use in playing games wherein the die includes a die body with multiple sides and wherein an electronic timer and a timer-responsive visual signal generating device and/or audio signal generating device is/are located on the body. A motion sensing device is disposed on the body to activate the timer to start timing when the die is used in playing the game.

U.S. Pat. No. 9,694,275 pertains to an electronic die capable of reporting roll results. The die can include an acceleration measurement system capable of outputting roll data. A processor can then interpret the roll data and transmit it through a wireless interface to a monitoring device. The monitoring device can then show a user the roll result. Waking the electronic die from a low power mode is also disclosed along with customizing the electronic die with faceplates and protective covers.

However, none of the references described above address the issues resolved by the embodiments of the present invention.

### SUMMARY OF THE EMBODIMENTS

The present invention and its embodiments relate to a timer apparatus. In an example embodiment of the present invention, the timer apparatus may include a first timing surface, a display surface, a stop surface, and a controller connected to an orientation sensor.

In another embodiment of the present invention, a timer apparatus may be described. The timer apparatus may include a timing surface, a display surface, a stop surface, and a controller connected to an orientation sensor. A shape of the timer apparatus may include a cube.

Furthermore, the controller may be configured to receive an orientation signal from the orientation sensor. The orientation signal may indicate the timing surface in a top position. Next, the display surface may be instructed to provide a timer. The timer may be configured to start counting down from a value displayed on the timing surface. The display surface may also be instructed to orient the timer in relation to the timing surface.

In yet another embodiment of the present invention, a method of providing a timer apparatus is described. The method may include receiving an orientation signal from an orientation sensor. A shape of the timer apparatus may include a cube. The signal may indicate a timing surface in a top position. Next, a display surface may be instructed to provide a timer. The timer may be configured to start counting down from a value displayed on the timing surface. The display surface may also be instructed to orient the timer in relation to the timing surface.

It is an object of the embodiment of the present invention to provide a timer apparatus.

It is another object of the embodiment of the present invention to initiate a timer to count down from a value displayed by a timing surface in response to detecting the timing surface in a top position.

It is yet another object of the embodiment of the present invention to orient the timer in a relation to a surface in the top position.

It is yet another object of the embodiment of the present invention to pause the timer when a display surface is detected in the top position.

It is yet another object of the embodiment of the present invention to emit an audible and/or a visual alarm when the timer reaches zero.

It is yet another object of the embodiment of the present invention to reset the timer when another timing surface is detected in the top position.

These and other features, aspects and advantages of the present invention will become better understood with reference to the following drawings, description and claims.

### BRIEF DESCRIPTION OF THE DRAWINGS

FIG. 1 shows a detailed view of an embodiment of the present invention.

FIG. 2 shows a detailed view of a display surface of an embodiment of the present invention.

FIG. 3 shows an interactive view of example scenarios associated with an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

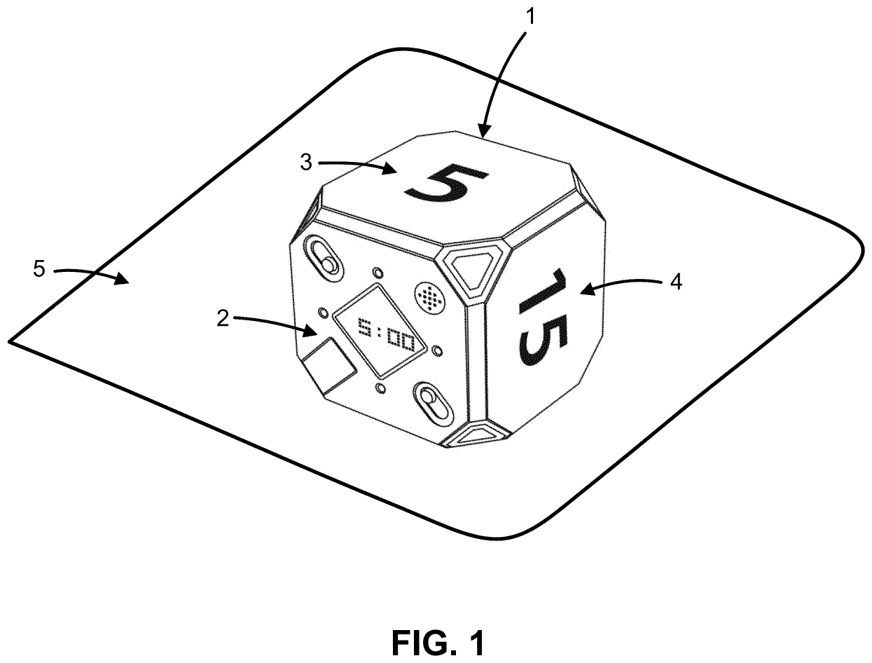

FIG. 1 shows a detailed view of a timer apparatus 1. A shape of the timer apparatus 1 may include a cube, a pyramid, a pentagonal prism, a hexagonal prism, or a polygonal prism. The shape of the timer apparatus 1 may preferably include a cube. The timer apparatus 1 may also include timing surface(s) such as a first timing surface 3 and a second timing surface 4. Each of the first and second timing surfaces (3 and 4) may display a value. The value may reflect minutes from which a timer (of the timer apparatus 1) may count down. The value may include 5, 15, 30, and/or 60 minutes, among others.

The timer apparatus 1 may also include a display surface 2. The display surface 2 may provide the timer. In an example scenario, the timer apparatus 1 may rest on a surface 5. A controller (such as an integrated circuit component) of the timer apparatus 1 may receive an orientation signal from an orientation sensor. The orientation signal may indicate the first timing surface 3 in a top position. The top position may include the first timing surface 3 positioned in parallel to the surface 5 while facing away from the surface 5. Based on the orientation signal, the controller may instruct the display surface 2 to provide the timer. The timer may be configured to count down from a first value displayed on the first timing surface 3. When the timer apparatus 1 is rotated from a timing surface (such as the timing surface 3 or 4) on the top position to the display surface 2 on the top position, the timer may be paused from a count down.

Furthermore, the timer apparatus 1 may also include a stop surface. The stop surface (when detected in the top position) may stop and reset the timer. In an example scenario, the stop surface may be positioned opposite from the display surface 2, as such face an opposite direction in relation to the display surface 2.

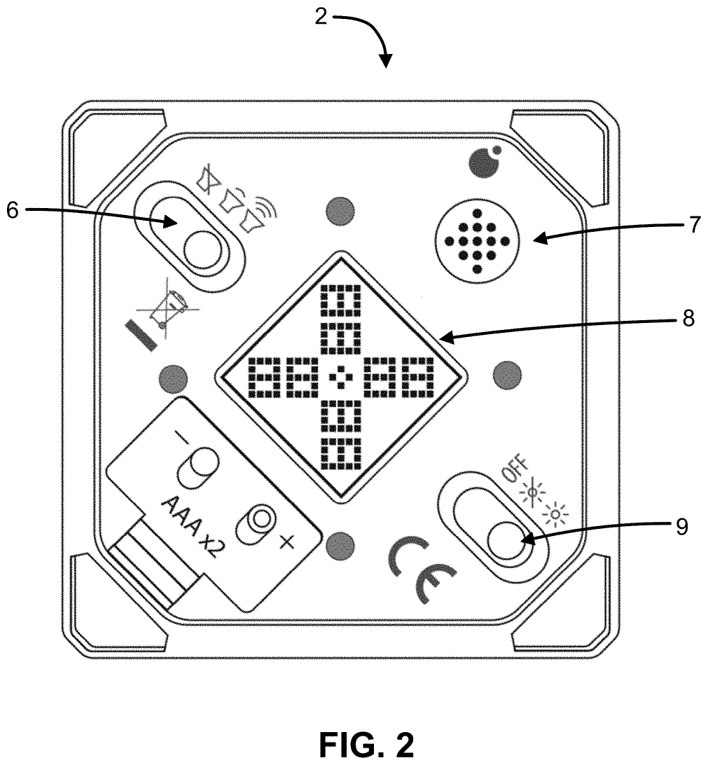

FIG. 2 shows a display surface 2 of the timer apparatus. The display surface 2 may include a timer 8 and an audio output component 7. The audio output component 7 may be configured to emit an audible alarm associated with the timer 8.

The display surface 2 may also include a volume control 6 configured to adjust a volume of the audible alarm. The display surface 2 may also include a brightness control. The brightness control may be configured to adjust a brightness of a visual output component such as the display surface 2 and/or the timer 8. The display surface 2 may also include a power control 9. The power control 9 may be configured to turn on or off one or more lighting components associated with the timer apparatus 1 based an input by a user. A lighting component may include a light emitter that may be used to provide the visual alarm.

In an example scenario, the timer 8 may be configured to orient based on an orientation change associated with the timer apparatus. For example, if a user rotates the timer apparatus, the timer 8 may re-orient to align horizontally in relation to one of the surfaces of the timer apparatus that is on the top position.

A controller of the timer apparatus may manage the timer 8 based on orientation signal(s) from the orientation sensor. For example, the controller may receive an orientation signal from the orientation sensor. The orientation signal may indicate one of the timing surfaces of the timer apparatus in the top position. The timing surface in the top position may display a value. Next, the controller may instruct the display surface 2 to provide the timer 8. The timer 8 may be configured to count down from the value (displayed by the surface in the top position). When the timer 8 reaches zero, the controller may instruct the audio output component 7 to emit an audible alarm. The controller may also instruct the display surface 2 to emit a visual alarm. An example of the visual alarm may include an animation and/or a blinking mechanism displayed by the timer 8 and/or lights associated with the display surface 2.

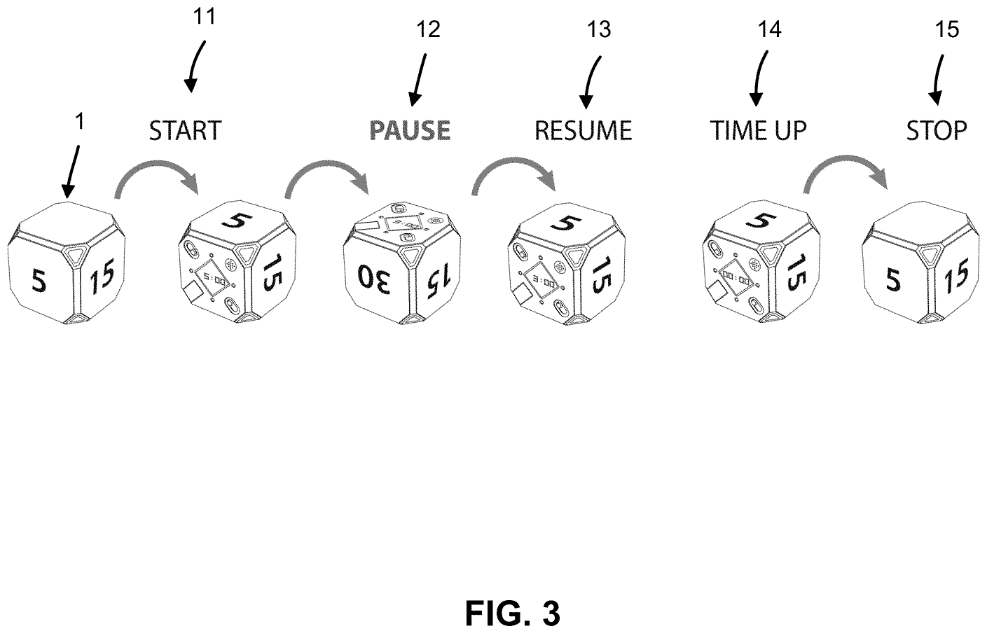

FIG. 3 shows an interactive view of example scenarios associated with the timer apparatus 1. For example, a user may re-orient the timer apparatus 1 by rotating a stop surface away from a top position. The first timing surface (displaying a first value) may be rotated to the top position. A rotation of the first timing surface to the top position may initiate a timer start process 11. An example of the first value may include 5 minutes.

Next, an orientation sensor (of the timer apparatus 1) may generate an orientation signal. The orientation signal may indicate the first timing surface in the top position. A controller of the timer apparatus 1 may receive the orientation signal and instruct the display surface to initiate a timer. The timer may be configured to count down from a value displayed by the first timing surface. The timer may also be oriented to align horizontally with the first timing surface.

Next, the user may rotate the first timing surface away from the top position and rotate the display surface to the top position. The rotation of the display surface to the top position may initiate a pause process 12. The orientation sensor may detect the display surface in the top position. In response, the orientation sensor may generate and transmit an orientation signal to the controller. The orientation signal may indicate the display surface in the top position. The controller may receive the orientation signal and instruct the display surface to pause the timer. In response, the display surface may pause a countdown of the timer.

In a subsequent action, the user may rotate the display surface away from the top position and rotate the first timing surface back to the top position in a resume process 13. The orientation sensor may detect the first timing surface in the top position, generate an orientation signal, and transmit the orientation signal to the controller. The orientation signal may indicate the first timing surface in the top position. Upon receiving the orientation signal, the controller may instruct the display surface to resume the timer and re-orient the timer to horizontally align with the first timing surface. In response, the display surface may resume a count down of the timer and re-orient the timer to align with the first timing surface.

Next, the timer may count down to zero in a time up process 14. In response, the controller may instruct alarm based components (such as an audio output, and/or visual output component) to emit an alarm such as an audible alarm and/or a visual alarm.

In an example scenario, the alarm based components may instruct the visual output components such as the display surface 2 and/or the timer 8 to gradually increase a brightness of display(s) and/or light(s) associated with the visual output components in response to a detected failure by the user to initiate an action to stop or reset the alarm. The increase in the brightness may aid in visually warning the user regarding the alarm.

In a subsequent action, the user may rotate the first timing surface away from the top position and rotate the stop surface to the top position in a stop process 15. The orientation sensor may detect the stop surface on the top position, generate an orientation signal, and transmit the orientation signal to the controller. The orientation signal may indicate the stop surface in the top position. The controller may receive the orientation signal. In response, the controller may instruct the display surface to stop emitting the alarm (if not already terminated based on a time limited duration) and reset the timer.

In another example scenario, the timer apparatus 1 may include timing surfaces displaying different set of values (such as 2, 4, 6, 8 or 5, 10, 15, 20, among others). Variations of the timer apparatus 1 may be produced based on the different set of values. Each of the set of values may represent a timer from which the timer apparatus 1 may count down. Furthermore, the timing surfaces may include electronic displays which may be configured to adjust the displayed value.

In yet another example scenario, the timer apparatus 1 may have alternative shapes. The timing surfaces may be increased by utilizing a polygon based shape such as a pentagonal, hexagonal, among other polygon based prisms or decreased by utilizing a pyramid, or other shape with fewer surfaces than a cube.

A method of providing a timer apparatus is also described. The method may include receiving an orientation signal from an orientation sensor. A shape of the timer apparatus may include a cube. Furthermore, the signal may indicate a timing surface in a top position. Next, a display surface may be instructed to provide a timer. The timer may be configured to start counting down from a value displayed on the timing surface. The display surface may also be instructed to orient the timer in relation to the timing surface.

In addition to the foregoing, other objects, features, aspects and advantages of the present invention will be better comprehended through a careful reading of a detailed description provided herein below with appropriate reference to the accompanying drawings.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A timer apparatus comprising:
a first timing surface,
a display surface,
a stop surface, and
a controller coupled to an orientation sensor.

2. The timer apparatus of claim 1, wherein a shape of the timer apparatus includes a cube.

3. The timer apparatus of claim 1, wherein a shape of the timer apparatus includes a pyramid, a pentagonal prism, a hexagonal prism, or a polygonal prism.

4. The timer apparatus of claim 1, wherein the first timing surface displays a first value.

5. The timer apparatus of claim 4, wherein the first value includes one from a set of 5, 15, 30, and 60 minutes.

6. The timer apparatus of claim 1, wherein the controller is configured to:
receive a first signal from the orientation sensor, wherein the first signal indicates the first timing surface in a top position;
instruct the display surface to provide a timer, wherein the timer is configured to start counting down from a first value displayed on the first timing surface; and
instruct the display surface to orient the timer in relation to the first timing surface.

7. The timer apparatus of claim 6, wherein the controller is further configured to:
detect the timer count down to zero; and
emit one or more of an audible alarm and a visual alarm.

8. The timer apparatus of claim 6, wherein the controller is further configured to:
receive a second signal from the orientation sensor, wherein the second signal describes the display surface in the top position; and
instruct the display surface to pause the timer.

9. The timer apparatus of claim 8, wherein the controller is further configured to:
receive a third signal from the orientation sensor, wherein the third signal describes the first timing surface in the top position; and
instruct the display surface to resume the timer.

10. The timer apparatus of claim 6, wherein the controller is further configured to:
receive a second signal from the orientation sensor, wherein the second signal indicates a second timing surface in the top position;
instruct the display surface to provide a new timer, the new timer is configured to count down from a second value displayed on the second timing surface; and
instruct the display surface to orient the new timer in relation to the second timing surface.

11. The timer apparatus of claim 6, wherein the controller is further configured to;
receive a second signal from the orientation sensor, wherein the second signal indicates the stop surface in the top position; and
instruct the display surface to re-set the timer.

12. The timer apparatus of claim 6, wherein the display surface includes:
a volume control configured to adjust a volume of an audible alarm associated with the timer.

13. A timer apparatus comprising:
a timing surface,
a display surface,
a stop surface, and
a controller coupled to an orientation sensor, wherein
a shape of the timer apparatus includes a cube, and wherein
the controller is configured to:
receive a signal from the orientation sensor, wherein the signal indicates the timing surface in a top position;
instruct the display surface to provide a timer, wherein the timer is configured to start counting down from a value displayed on the timing surface; and
instruct the display surface to orient the timer in relation to the timing surface.

14. A method of providing a timer apparatus, the method comprising:
receiving a signal from an orientation sensor, wherein a shape of the timer apparatus includes a cube, and wherein the signal indicates a timing surface in a top position;
instructing a display surface to provide a timer, wherein the timer is configured to start counting down from a value displayed on the timing surface; and
instructing the display surface to orient the timer in relation to the timing surface.
